(19) United States
(12) Patent Application Publication
(10) Pub. No.: US 2026/0143397 A1
(43) Pub. Date: May 21, 2026

(54) METHOD AND APPARATUS FOR TRAFFIC STEERING IN OPEN RADIO ACCESS NETWORK

(71) Applicant: ELECTRONICS AND TELECOMMUNICATIONS RESEARCH INSTITUTE, Daejeon (KR)

(72) Inventors: Seung Eun HONG, Daejeon (KR); Jeehyeon NA, Daejeon (KR); Jung Mo MOON, Daejeon (KR)

(21) Appl. No.: 19/393,244

(22) Filed: Nov. 18, 2025

(30) Foreign Application Priority Data
Nov. 19, 2024 (KR) 10-2024-0165692
Nov. 17, 2025 (KR) 10-2025-0173840

(51) Int. Cl. H04W 36/22; H04L 41/16; H04W 24/02; H04W 28/02

(52) U.S. Cl. CPC H04W 36/22; H04L 41/16; H04W 24/02; H04W 28/0215

(57) ABSTRACT

A method of a radio access network (RAN) intelligent controller (RIC) may comprise: receiving, from a base station, RAN data for each of a plurality of terminals; predicting, based on the RAN data and by using an abnormal terminal detection model, at least one abnormal terminal among the plurality of terminals to generate abnormal terminal information; and transmitting, to the base station, at least one of the abnormal terminal information or a handover control message for the at least one abnormal terminal.

### CROSS-REFERENCE TO RELATED APPLICATIONS

This application claims priority to Korean Patent Applications No. 10-2024-0165692, filed on Nov. 19, 2024, and No. 10-2025-0173840, filed on Nov. 17, 2025, with the Korean Intellectual Property Office (KIPO), the entire contents of which are hereby incorporated by reference.

### BACKGROUND

### 1. Technical Field

The present disclosure relates to a traffic steering technique in an open radio access network (O-RAN), and more particularly, to a traffic steering method and apparatus for detecting an abnormal user equipment (UE) to perform handover control in an O-RAN.

### 2. Related Art

With the development of information and communication technology, various wireless communication technologies have been developed. Typical wireless communication technologies include long term evolution (LTE) and new radio (NR), which are defined in the 3rd generation partnership project (3GPP) standards. The LTE may be one of 4th generation (4G) wireless communication technologies, and the NR may be one of 5th generation (5G) wireless communication technologies.

For the processing of rapidly increasing wireless data after the commercialization of the 4th generation (4G) communication system (e.g. Long Term Evolution (LTE) communication system or LTE-Advanced (LTE-A) communication system), the 5th generation (5G) communication system (e.g. new radio (NR) communication system) that uses a frequency band (e.g. a frequency band of 6 GHz or above) higher than that of the 4G communication system as well as a frequency band of the 4G communication system (e.g. a frequency band of 6 GHz or below) is being considered. The 5G communication system may support enhanced Mobile BroadBand (eMBB), Ultra-Reliable and Low-Latency Communication (URLLC), and massive Machine Type Communication (mMTC).

Recently, open radio access network (O-RAN) technology is being developed, which goes beyond standardized radio and baseband equipment to disaggregate a radio access network (RAN) into smaller components and to accelerate the establishment of an open ecosystem and technological innovation through the standardization of interfaces among the components. The disaggregation and virtualization characteristics of O-RAN provide a structure that is highly advantageous for energy saving by setting energy efficiency targets for each component and developing techniques to achieve these targets. In particular, resource and power usage can be optimized through artificial intelligence/machine learning (AI/ML) on an RAN intelligent controller (RIC) framework of O-RAN.

In a traffic steering scenario of the O-RAN system, user-perceived quality can be improved by intelligently or automatically adjusting user traffic among multiple cells through performance monitoring and control at the user level. However, in the O-RAN system accommodating multiple cells and users, it may be difficult to perform monitoring and control for all users. Therefore, there is a need for traffic steering schemes that can improve user-perceived quality and cell load balancing in the O-RAN system.

### SUMMARY

The present disclosure for resolving the above-described problems is directed to providing a traffic steering method and apparatus for traffic steering in an O-RAN.

According to a first exemplary embodiment of the present disclosure, a method of a radio access network (RAN) intelligent controller (RIC) may comprise: receiving, from a base station, RAN data for each of a plurality of terminals; predicting, based on the RAN data and by using an abnormal terminal detection model, at least one abnormal terminal among the plurality of terminals to generate abnormal terminal information; and transmitting, to the base station, at least one of the abnormal terminal information or a handover control message for the at least one abnormal terminal.

The generating of the abnormal terminal information may comprise: generating signal prediction information for the at least one abnormal terminal based on the RAN data; generating cell load prediction information for the at least one abnormal terminal based on the RAN data; and generating the abnormal terminal information including at least one of the signal prediction information or the cell load prediction information.

The generating of the abnormal terminal information may further comprise: generating quality of service (QoS) prediction information for the at least one abnormal terminal based on the RAN data; and generating the abnormal terminal information including at least one of the signal prediction information, the cell load prediction information, or the QoS prediction information.

The method may further comprise optimizing the abnormal terminal detection model, wherein the optimizing may comprise: combining, by using expert knowledge, at least one of a plurality of features of each of a plurality of data samples; selecting at least one feature among the plurality of features to train the abnormal terminal detection model; determining, based on a training result, whether performance improvement of the abnormal terminal detection model is required; based on determining that the performance improvement is not required, storing model performance metrics for the selected at least one feature; and optimizing the abnormal terminal detection model based on a feature corresponding to an optimal performance metric among the stored model performance metrics.

The optimizing may further comprise: repeatedly training the abnormal terminal detection model according to preset weights, based on determining that the performance improvement of the abnormal terminal detection model is required.

The optimizing may further comprise: reselecting at least one other feature among the plurality of features, based on determining that a number of the selected at least one feature is smaller than a total number of the plurality of features.

The optimizing may further comprise: distinguishing, by using expert knowledge, each of the plurality of data samples as a normal data sample or an abnormal data sample; and extracting the normal data samples by filtering the plurality of data samples.

The abnormal terminal detection model may comprise a first model and a second model connected in series, and the optimizing may further comprise: outputting, by using the first model, a prediction result for the selected at least one feature; and optimizing the second model based on the prediction result of the first model.

The method may further comprise: transmitting a RAN data subscription request to the base station; and receiving, from the base station, the RAN data for each of the plurality of terminals based on the subscription request.

According to a second exemplary embodiment of the present disclosure, a radio access network (RAN) intelligent controller (RIC) may comprise at least one processor, and the at least one processor may cause the RAN intelligent controller to: receive, from a base station, RAN data for each of a plurality of terminals; predict, based on the RAN data and by using an abnormal terminal detection model, at least one abnormal terminal among the plurality of terminals to generate abnormal terminal information; and transmit, to the base station, at least one of the abnormal terminal information or a handover control message for the at least one abnormal terminal.

In the generating of the abnormal terminal information, the at least one processor may cause the RAN intelligent controller to: generate signal prediction information for the at least one abnormal terminal based on the RAN data; generate cell load prediction information for the at least one abnormal terminal based on the RAN data; and generate the abnormal terminal information including at least one of the signal prediction information or the cell load prediction information.

In the generating of the abnormal terminal information, the at least one processor may cause the RAN intelligent controller to: generate quality of service (QoS) prediction information for the at least one abnormal terminal based on the RAN data; and generate the abnormal terminal information including at least one of the signal prediction information, the cell load prediction information, or the QoS prediction information.

The at least one processor may further cause the RAN intelligent controller to: combine, by using expert knowledge, at least one of a plurality of features of each of a plurality of data samples; select at least one feature among the plurality of features to train the abnormal terminal detection model; determine, based on a training result, whether performance improvement of the abnormal terminal detection model is required; based on determining that the performance improvement is not required, store model performance metrics for the selected at least one feature; and optimize the abnormal terminal detection model based on a feature corresponding to an optimal performance metric among the stored model performance metrics.

The at least one processor may further cause the RAN intelligent controller to: repeatedly train the abnormal terminal detection model according to preset weights, based on determining that the performance improvement of the abnormal terminal detection model is required.

The at least one processor may further cause the RAN intelligent controller to: reselect at least one other feature among the plurality of features, based on determining that a number of the selected at least one feature is smaller than a total number of the plurality of features.

The at least one processor may further cause the RAN intelligent controller to: distinguish, by using expert knowledge, each of the plurality of data samples as a normal data sample or an abnormal data sample; and extract the normal data samples by filtering the plurality of data samples.

The abnormal terminal detection model may comprise a first model and a second model connected in series, and the at least one processor may further cause the RAN intelligent controller to: output, by using the first model, a prediction result for the selected at least one feature; and optimize the second model based on the prediction result of the first model.

The at least one processor may further cause the RAN intelligent controller to: transmit a RAN data subscription request to the base station; and receive, from the base station, the RAN data for each of the plurality of terminals based on the subscription request.

According to the present disclosure, a RAN intelligent controller can detect at least one terminal exhibiting an abnormal condition among a plurality of terminals in an open radio access network, and can transmit, to a base station (or E2 node), information for performing handover of the detected abnormal terminal. Accordingly, the RAN intelligent controller can adjust user traffic of each of multiple cells in the communication network by detecting the abnormal terminal, thereby improving user-perceived quality and enhancing cell load balancing.

### BRIEF DESCRIPTION OF DRAWINGS

FIG. 1 is a conceptual diagram illustrating exemplary embodiments of a communication system.

FIG. 2 is a block diagram illustrating exemplary embodiments of a communication node constituting a communication system.

FIG. 3 is a conceptual diagram illustrating an exemplary embodiment of interfaces among components of an open radio access network system.

FIG. 4 is a conceptual diagram illustrating an exemplary embodiment of interfaces among components of an AI radio access network system.

FIG. 5 is a sequence chart illustrating an exemplary embodiment of a traffic steering method of an open radio access network system.

FIG. 6 is a block diagram illustrating an exemplary embodiment of an abnormal terminal detection model of a RAN intelligent controller.

FIG. 7 is a block diagram illustrating another exemplary embodiment of an abnormal terminal detection model of a RAN intelligent controller.

FIG. 8 is a conceptual diagram illustrating an exemplary embodiment of an isolation forest model for abnormal terminal detection.

FIG. 9 is a conceptual diagram illustrating an exemplary embodiment of an autoencoder model for abnormal terminal detection.

FIG. 10 is a conceptual diagram illustrating an exemplary embodiment for optimization of an isolation forest model.

FIG. 11 is a flowchart illustrating an exemplary embodiment of a method for optimization of an isolation forest model.

FIG. 12 is a conceptual diagram illustrating an exemplary embodiment for optimization of an autoencoder model.

FIG. 13 is a flowchart illustrating an exemplary embodiment of a method for optimization of an autoencoder model.

FIG. 14 is a conceptual diagram illustrating an exemplary embodiment for optimization of a plurality of autoencoder models.

FIG. 15 is a conceptual diagram illustrating an exemplary embodiment for optimization of a hybrid model.

FIG. 16 is a conceptual diagram illustrating another exemplary embodiment for optimization of a hybrid model.

FIG. 17 is a conceptual diagram illustrating yet another exemplary embodiment for optimization of a hybrid model.

### DETAILED DESCRIPTION OF THE EMBODIMENTS

Exemplary embodiments of the present disclosure are disclosed herein. However, specific structural and functional details disclosed herein are merely representative for purposes of describing embodiments of the present disclosure. Thus, embodiments of the present disclosure may be embodied in many alternate forms and should not be construed as limited to embodiments of the present disclosure set forth herein.

Accordingly, while the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

A communication network to which exemplary embodiments according to the present disclosure are applied will be described. The communication network may be a non-terrestrial network (NTN), a 4G communication network (e.g. Long-Term Evolution (LTE) communication network), a 5G communication network (e.g. New Radio (NR) communication network), or a B5G mobile communication network (e.g. 6G mobile communication network). The 4G communication network and the 5G communication network may be classified as terrestrial networks.

In exemplary embodiments, “an operation (e.g. transmission operation) is configured” may mean that “configuration information (e.g. information element(s) or parameter(s)) for the operation and/or information indicating to perform the operation is signaled”. “Information element(s) (e.g. parameter(s)) are configured” may mean that “corresponding information element(s) are signaled”. The signaling may be at least one of system information (SI) signaling (e.g. transmission of system information block (SIB) and/or master information block (MIB)), RRC signaling (e.g. transmission of RRC parameters and/or higher layer parameters), MAC control element (CE) signaling, or PHY signaling (e.g. transmission of downlink control information (DCI), uplink control information (UCI), and/or sidelink control information (SCI)).

In the present disclosure, even when a method (e.g. transmission or reception of a signal) performed at a first communication node among communication nodes is described, a corresponding second communication node may perform a method (e.g. reception or transmission of the signal) corresponding to the method performed at the first communication node. That is, when an operation of a terminal is described, a base station corresponding to the terminal may perform an operation corresponding to the operation of the terminal. Conversely, when an operation of a base station is described, a terminal corresponding to the base station may perform an operation corresponding to the operation of the base station. In addition, when an operation of a first terminal is described, a second terminal corresponding to the first terminal may perform an operation corresponding to the operation of the first terminal. Conversely, when an operation of a second terminal is described, a first terminal corresponding to the second terminal may perform an operation corresponding to the operation of the second terminal.

In the present disclosure, a phrase including “when ˜” may be expressed as a phrase including “based on ˜” or as a phrase including “in response to ˜”. In other words, a phrase including “when ˜” may be interpreted as being the same as or similar to a phrase including “based on ˜” or a phrase including “in response to ˜”.

Throughout the present disclosure, a terminal may refer to a mobile station, mobile terminal, subscriber station, portable subscriber station, user equipment, access terminal, or the like, and may include all or a part of functions of the terminal, mobile station, mobile terminal, subscriber station, mobile subscriber station, user equipment, access terminal, or the like.

Here, a desktop computer, laptop computer, tablet PC, wireless phone, mobile phone, smart phone, smart watch, smart glass, e-book reader, portable multimedia player (PMP), portable game console, navigation device, digital camera, digital multimedia broadcasting (DMB) player, digital audio recorder, digital audio player, digital picture recorder, digital picture player, digital video recorder, digital video player, or the like having communication capability may be used as the terminal.

Throughout the present specification, the base station may refer to an access point, radio access station, node B (NB), evolved node B (eNB), base transceiver station, mobile multihop relay (MMR)-BS, or the like, and may include all or part of functions of the base station, access point, radio access station, NB, eNB, base transceiver station, MMR-BS, or the like.

Hereinafter, preferred exemplary embodiments of the present disclosure will be described in more detail with reference to the accompanying drawings. In describing the present disclosure, in order to facilitate an overall understanding, the same reference numerals are used for the same elements in the drawings, and duplicate descriptions for the same elements are omitted.

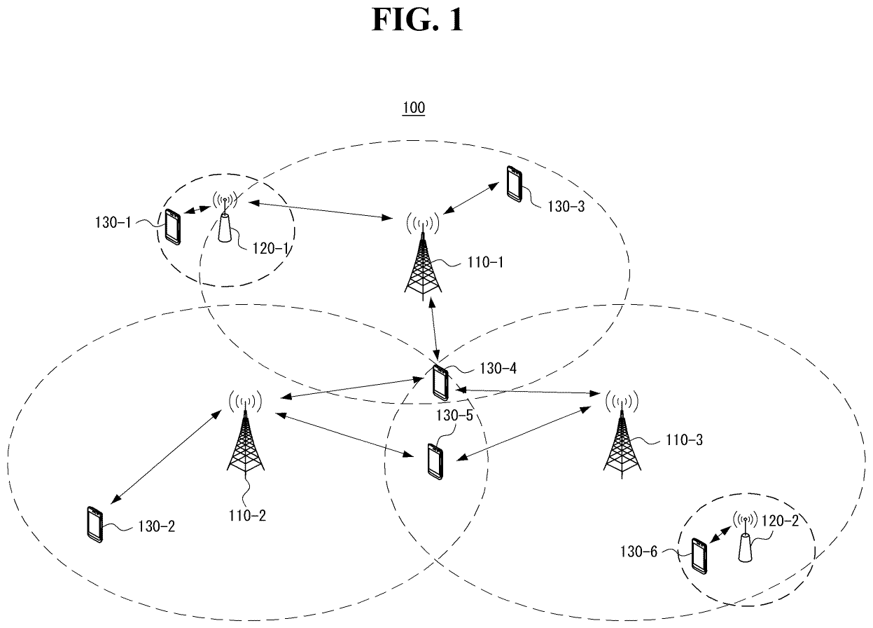

FIG. 1 is a conceptual diagram illustrating exemplary embodiments of a communication system.

Referring to FIG. 1, a communication system 100 may comprise a plurality of communication nodes 110-1, 110-2, 110-3, 120-1, 120-2, 130-1, 130-2, 130-3, 130-4, 130-5, and 130-6. The plurality of communication nodes 110-1, 110-2, 110-3, 120-1, 120-2, 130-1, 130-2, 130-3, 130-4, 130-5, and 130-6 may include a plurality of base stations 110-1, 110-2, 110-3, 120-1, and 120-2) and a plurality of terminals, for example, a plurality of user terminals 130-1, 130-2, 130-3, 130-4, 130-5, and 130-6.

Each of the plurality of communication nodes 110-1, 110-2, 110-3, 120-1, 120-2, 130-1, 130-2, 130-3, 130-4, 130-5, and 130-6 may support 4G communication (e.g. long term evolution (LTE), LTE-advanced (LTE-A)), 5G communication (e.g. new radio (NR)), 6G communication, etc. specified in the 3rd generation partnership project (3GPP) standards. The 4G communication may be performed in frequency bands below 6 GHz, and the 5G and 6G communication may be performed in frequency bands above 6 GHz as well as frequency bands below 6 GHz.

For example, in order to perform the 4G communication, 5G communication, and 6G communication, the plurality of communication may support a code division multiple access (CDMA) based communication protocol, wideband CDMA (WCDMA) based communication protocol, time division multiple access (TDMA) based communication protocol, frequency division multiple access (FDMA) based communication protocol, orthogonal frequency division multiplexing (OFDM) based communication protocol, filtered OFDM based communication protocol, cyclic prefix OFDM (CP-OFDM) based communication protocol, discrete Fourier transform spread OFDM (DFT-s-OFDM) based communication protocol, orthogonal frequency division multiple access (OFDMA) based communication protocol, single carrier FDMA (SC-FDMA) based communication protocol, non-orthogonal multiple access (NOMA) based communication protocol, generalized frequency division multiplexing (GFDM) based communication protocol, filter bank multi-carrier (FBMC) based communication protocol, universal filtered multi-carrier (UFMC) based communication protocol, space division multiple access (SDMA) based communication protocol, orthogonal time-frequency space (OTFS) based communication protocol, or the like.

Further, the communication system 100 may further include a core network (not shown). When the communication 100 supports 4G communication, the core network may include a serving gateway (S-GW), packet data network (PDN) gateway (P-GW), mobility management entity (MME), and the like. When the communication system 100 supports 5G communication or 6G communication, the core network may include a user plane function (UPF), session management function (SMF), access and mobility management function (AMF), and the like.

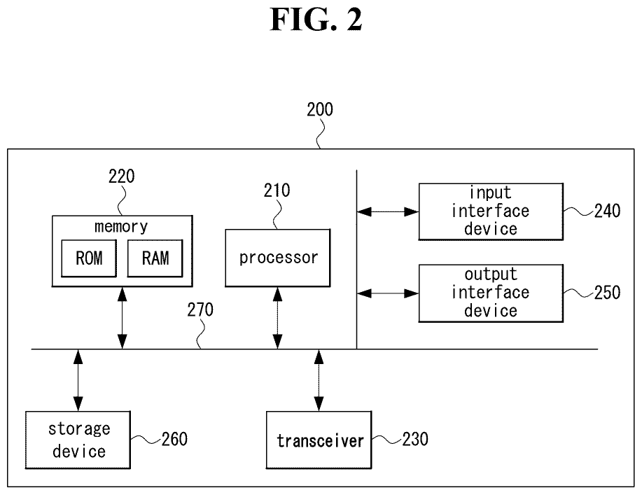

FIG. 2 is a block diagram illustrating exemplary embodiments of a communication node constituting a communication system.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. Each component included in the communication node 200 may communicate with each other as connected through a bus 270.

However, each component included in the communication node 200 may not be connected to the common bus 270 but may be connected to the processor 210 via an individual interface or a separate bus. For example, the processor 210 may be connected to at least one of the memory 220, the transceiver 230, the input interface device 240, the output interface device 250 and the storage device 260 via a dedicated interface.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed.

Each of the memory 220 and the storage device 260 may be constituted by at least one of a volatile storage medium and a non-volatile storage medium. For example, the memory 220 may comprise at least one of read-only memory (ROM) and random access memory (RAM).

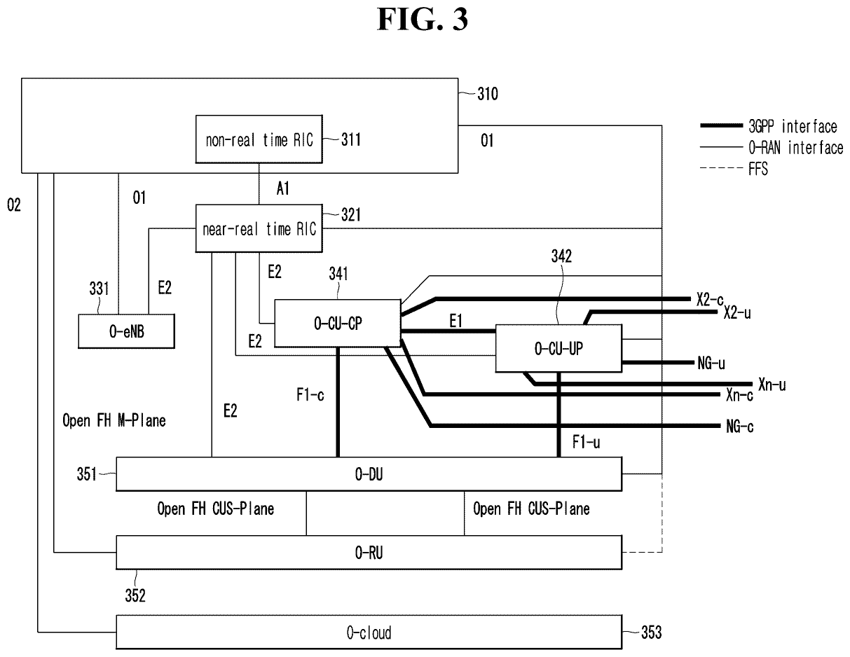

FIG. 3 is a conceptual diagram illustrating an exemplary embodiment of interfaces among components of an open radio access network system.

Referring to FIG. 3, an open radio access network (O-RAN) system may be based on open interfaces enabling interaction between a RAN intelligent controller (RIC) and a RAN.

A service management and orchestration (SMO) framework 310 of the O-RAN may include a non-real time RIC 311. The SMO framework 310 may be connected to a near-real time RIC 321, an O-eNB 331, an O-CU-CP 341, an O-CU-UP 342, and an O-DU 351 through O1 interfaces. The SMO framework 310 may further be connected to an O-RU 352 through an open FH M-plane interface, and may be connected to an O-cloud 353 through an O2 interface.

Here, the O-CU may refer to a central unit (CU) of the O-RAN, and an O-DU may refer to a distributed unit (DU) of the O-RAN, and an O-RU may refer to a radio unit (RU) of the O-RAN. In addition, a relationship between a control plane (CP) and a user plane (UP) is illustrated. Therefore, the O-CU-CP 341 may refer to a CP included in the O-CU, and the O-CU-UP 342 may refer to a UP included in the O-CU.

The near-real time RIC 321 may be connected to the O-eNB 331, the O-CU-CP 341, the O-CU-UP 342, and the O-DU 351 through E2 interfaces. The near-real time RIC 321 may be connected to the non-real time RIC 311 through an A1 interface.

The O-CU-CP 341 may be connected to the O-CU-UP 342 through an E1 interface, and may be connected to the O-DU 351 through an F1-c interface. The O-CU-CP 341 may further be connected to other nodes of a 3GPP network through an X2-c interface, an Xn-c interface, and an NG-c interface.

The O-CU-UP 342 may be connected to the O-DU 351 through an F1-u interface. The O-CU-UP 342 may further be connected to other nodes of the 3GPP network through an X2-u interface, an Xn-u interface, and an NG-u interface.

The O-DU 351 may be connected to the O-RU 352 through an open FH CUS-plane interface and an open FH M-plane interface.

The non-real time RIC 311 included in the SMO framework 310 may be a logical functional block and may perform non-real time control on RAN elements and resources through fine-grained data collection via the O1 interfaces. More specifically, the non-real time RIC 311 may manage overall configuration of the network through fine-grained data collection and may obtain Artificial Intelligence (AI) based feeds to provide recommendations to the near-real time RIC 321. The non-real time RIC 311 may provide to the near-real time RIC 321, through the A1 interface, policies, enrichment information, and machine learning (ML) model management information. The non-real time RIC 311 may receive policy feedback from the near-real time RIC 321 through the A1 interface.

The near-real time RIC 321 may be a logical functional block that performs near-real time control, optimizes RAN elements and resources, performs AI/ML workflows including model training and updating, and provides policy-based guidance to applications within the near-real time RIC 321. The near-real time RIC 321 may control the RAN by using eXtended applications (xApps). The near-real time RIC 321 may enable optimization of real-time or near-real-time control on RAN elements (also referred to as E2 nodes) through tasks transmitted through the E2 interfaces. The near-real time RIC 321 may transmit RIC control and policy information to the RAN elements through the E2 interfaces and may receive feedback regarding the RIC control and policy information.

The xApp may control operations such as handover optimization, radio link monitoring, radio resource management, mobility management, load balancing, slicing policy update, traffic steering, interference management, and security. In other words, a first xApp may be an application for optimizing handover, and a second xApp may be an application for radio link monitoring. Various types of xApps that are to be executed in the near-real time RIC 321 may be introduced. The xApp may perform control of a specific operation within a delay time of 10 ms to less than 1 second.

The O-eNB 331 may refer to a third generation (3G) base station and a fourth generation (4G) base station capable of connecting to the SMO framework 310 of the O-RAN. The O-eNB 331 may be connected to the near-real time RIC 321 through the E2 interface. Therefore, the O-eNB 331 may be controlled by the xApp(s) mounted in the near-real time RIC 321 or may provide feedback of information requested by the xApp(s) mounted in the near-real time RIC 321. Other operations may be the same as operations of the typical third or fourth generation base station.

The O-CU-CP 341 may be a control plane (CP) of the O-CU, and may be a logical node hosting a Radio Resource Control (RRC) layer and a control plane part of a Packet Data Convergence Protocol (PDCP) according to the specifications of the O-RAN alliance.

The O-CU-UP 342 may be a user plane (UP) of the O-CU, and may be a logical node hosting a user plane part of the PDCP and a Service Data Adaptation Protocol (SDAP) according to the specifications of the O-RAN alliance.

The O-DU may be a logical node based on lower-layer functional split of the O-CU (including the O-CU-CP 341 and the O-CU-UP 342), and may host a Radio Link Control (RLC) layer, a Medium Access Control (MAC) layer, and an upper (High) physical (PHY) layer.

The O-RU 352 may be a logical node hosting radio frequency (RF) processing and a lower (Low) physical (PHY) layer based on lower-layer functional split.

The O-cloud 353 may be a set of hardware and software providing cloud computing for hosting and executing O-RAN network functions.

The O-RAN defined above defines a RAN in a virtualized form on open hardware. The O-RAN further defines standardized interfaces compliant with 3GPP and related mobile communication specifications to realize an open and highly compatible supply ecosystem. In addition, as described above, the RIC is separated into the non-real time RIC 311 and the near-real time RIC 321 for AI and/or ML based RAN control.

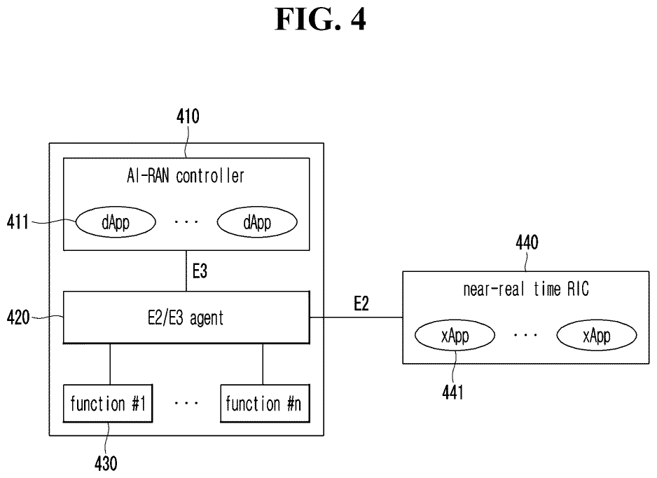

FIG. 4 is a conceptual diagram illustrating an exemplary embodiment of interfaces among components of an AI radio access network system.

Referring to FIG. 4, an AI radio access network (AI-RAN) system may be based on open interfaces enabling interaction between an RAN and an RIC. The RAN may include an AI-RAN controller 410, an E2/E3 agent 420, and a plurality of function units 430. Each of the plurality of function units 430 may include at least one of O-CUs, O-DUs, or O-RUs. The RIC may be a near-real time RIC 440.

The AI-RAN controller 410 may finely adjust RAN operations such as resource allocation, slicing, handover, mobility management, spectrum coexistence, and energy saving/efficiency through algorithms. The AI-RAN controller 410 may include dApps 411 operating to perform RAN control functions. The dApps 411 may perform RAN control functions alone or in cooperation with other dApps 411. According to an exemplary embodiment, the dApps 411 may perform RAN control functions in cooperation with xApps 441 operating in the near-real time RIC 440.

The E2/E3 agent 420 may manage E3 interfaces for interworking between the AI-RAN controller 410 and the plurality of function units 430 or may manage E2 interfaces for interworking between the AI-RAN controller 410 or the plurality of function units 430 and the near-real time RIC 440. The AI-RAN controller 410 may receive all data related to the RAN through the E3 interfaces of the E2/E3 agent 420. The near-real time RIC 440 may receive all data related to the RAN through the E2 interfaces of the E2/E3 agent 420. The E2/E3 agent 420 may be separated into an E2 agent and an E3 agent according to their functions.

Hereinafter, a traffic steering method for cell load distribution and improvement of quality of experience of terminals in the O-RAN system or AI-RAN system and an apparatus for the same, for example, a RIC, will be described. For convenience of description, the present disclosure describes a traffic steering method of the O-RAN system. However, the same traffic steering method may be performed also in the AI-RAN system.

The RIC (e.g. non-real time RIC or near-real time RIC) and RAN nodes (e.g. O-CU/O-DU/O-RU) according to the O-RAN system architecture may also be applied to base stations of other wireless communication systems in addition to the 5G NR base station, for example, to base stations (or network nodes corresponding thereto) of the LTE communication system, a sixth generation (6G) communication system, or WiFi. The same may also be applied to a 5G gNB, a 4G eNB, or a WiFi base station in which base station functions are not split into CU/DU/RU. An rApp or an xApp installed (or mounted) in the non-real time RIC or the near-real time RIC of O-RAN may be an application programmed to perform control for traffic steering in interworking with E2 nodes (e.g. O-CU/O-DU) or RAN nodes.

In the following description, in order to indicate an operating method of the present disclosure clearly and simply, description will be made based on FIG. 3 reflecting a functional-split base station architecture. However, it is obvious that the method described below may be applied in the same or a similar manner even in the case of base stations in which functions are not split.

An O-RAN system according to the present disclosure may centrally control a plurality of O-CUs/O-DUs/O-RUs or base stations through the near-real time RIC 321. In addition, the near-real time RIC 321 may intelligently control the RAN through AI/ML model training and inference. In an exemplary embodiment, the near-real time RIC 321 may control RAN nodes in interworking with the non-real time RIC 311 through the A1 interface. Alternatively, the near-real time RIC 321 and the non-real time RIC 311 may each control RAN nodes individually.

The RAN nodes may collect various data through the O1 interfaces or the E2 interfaces, for example, data for detection of abnormal terminals. The data collected by each of the RAN nodes may be provided to the near-real time RIC 321. The near-real time RIC 321 may train an AI/ML model and perform inference based on the AI/ML model by using the collected data and may generate control information for RAN control. The near-real time RIC 321 can control the RAN nodes through the O1 interfaces or the E2 interfaces by using the generated control information.

The near-real time RIC 321 may collect key performance measurement (KPM) data at a terminal level from each of RAN nodes, for example, from E2 nodes. As shown in Table 1 below, KPM data may include at least one of a terminal identifier, QoS information, a serving cell identifier, a serving cell load level, serving cell RF signal quality, a neighbor cell identifier, or neighbor cell RF signal quality. The serving cell load level may be indicated by a quantity of physical resource block (PRB) usage used in downlink and uplink of all terminals in a cell including the corresponding terminal. The QoS information may be indicated by a target throughput to be provided to the corresponding terminal and an actual service throughput. The serving cell RF signal quality may be indicated by at least one of reference signal receiving power (RSRP), reference signal receiving quality (RSRQ), or a signal-to-interference-plus-noise ratio (RS_SINR) of a reference signal between the corresponding terminal and a serving cell.

TABLE 1

| Item | Interfaces | Description |
|---|---|---|
| MeasurementTimeStamp | O1/E2/E3 | Performance measurement time |
| UE_ID | O1/E2/E3 | UE identifier |
| DL_PDCP_tput_Mbps | O1/E2/E3 | Amount of downlink (DL) PDCP |
| | | data transmitted to the UE during a |
| | | given time window |
| Target_DL_PDCP_{—} | O1/E2/E3 | Target amount of DL PDCP data to |
| tput_Mbps | | be provided to the UE |
| UL_PDCP_tput_Mbps | O1/E2/E3 | Amount of uplink (UL) PDCP data |
| | | received from the UE during a |
| | | given time window |
| Target_UL_PDCP_{—} | O1/E2/E3 | Target amount of UL PDCP data to |
| tput_Mbps | | be provided to the UE |
| servCell_ID | O1/E2/E3 | Serving-cell identifier of a given |
| | | UE |
| DL_PRB_usage_{—} | O1/E2/E3 | DL PRB usage rate of a serving |
| servCell | | cell of a given UE |
| UL_PRB_usage_{—} | O1/E2/E3 | UL PRB usage rate of a serving |
| servCell | | cell of a given UE |
| RS_SINR_dB_servCell | O1/E2/E3 | RS SINR measurement reported to |
| | | the serving cell from the UE |
| RSRP_dBm_servCell | O1/E2/E3 | RSRP measurement reported to the |
| | | serving cell from the UE |
| RSRQ_dB_servCell | O1/E2/E3 | RSF measurement reported to the |
| | | serving cell from the UE |
| nbrCell#1_ID | O1/E2/E3 | Identifier of neighbor cell #1 of |
| | | a given UE |
| RS_SINR_dB_{—} | O1/E2/E3 | RS SINR measurement for |
| nbrCell#1 | | neighbor cell #1 reported from |
| | | the UE |
| RSRP_dBm_nbrCell#1 | O1/E2/E3 | RSRP measurement for neighbor |
| | | cell #1 reported from the UE |
| RSRQ_dB_nbrCell#1 | O1/E2/E3 | RSRQ measurement for neighbor |
| | | cell #1 reported from the UE |
| . | . | . |
| . | . | . |
| . | . | . |
| nbrCell#n_ID | O1/E2/E3 | Identifier of neighbor cell #n of |
| | | a given UE |
| RS_SINR_dB_{—} | O1/E2/E3 | RS SINR measurement for |
| nbrCell#n | | neighbor cell #n reported from |
| | | the UE |
| RSRP_dBm_nbrCell#n | O1/E2/E3 | RSRP measurement for neighbor |
| | | cell #n reported from the UE |
| RSRQ_dB_nbrCell#n | O1/E2/E3 | RSRQ measurement for neighbor |
| | | cell #n reported from the UE |
| location (x-pos, y-pos) | O1/E2/E3 | Location information of active UEs |
| | | per cell |
| . | . | . |
| . | . | . |
| . | . | . |

The near-real time RIC 321 may periodically collect data from E2 nodes through E2 interfaces. The near-real time RIC 321 may collect data based on a collection periodicity set so as to determine states of terminals and cells in a near-real time manner while preventing overload of the E2 interfaces. For example, the collection periodicity may be set to 1 ms, 10 ms, or 100 ms. The near-real time RIC 321 may detect abnormal terminal(s) based on the collected data and may perform traffic steering through, for example, handover control for the detected terminal(s).

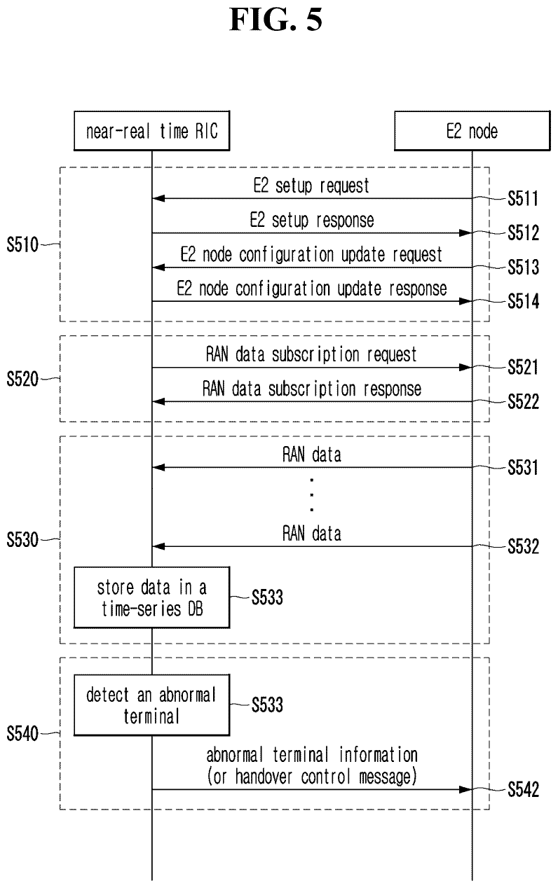

FIG. 5 is a sequence chart illustrating an exemplary embodiment of a traffic steering method of an open radio access network system.

Referring to FIG. 3 and FIG. 5, the near-real time RIC 321 may collect RAN data, for example, KPM data, from an E2 node through an E2 interface, and may perform traffic steering based on the collected RAN data. The E2 node may be one of RAN nodes into which base station functions are split (e.g. O-CU/O-DU/O-RU) or may be a base station whose functions are not split.

The near-real time RIC 321 may perform traffic steering through an E2 setup and node configuration update step S510, an RIC subscription step S520, an RIC indication step S530, and an abnormal UE detection step S540.

In the E2 setup and node configuration update step S510, at least one E2 node may transmit an E2 setup request message to the near-real time RIC 321 (S511). The near-real time RIC 321 may establish, through a stream control transmission protocol (SCTP), an interface with the E2 node, for example, an E2 application protocol (E2AP) link, based on the E2 setup request message. The E2 interface may be an interface established for control or data collection between the near-real time RIC 321 and the E2 node. The near-real time RIC 321 may transmit an E2 setup response message to the E2 node (S512).

The E2 node may transmit an E2 node configuration update request message to the near-real-time RIC 321 based on the E2 setup response message (S513). For example, the E2 node may transmit to the near-real-time RIC a list of RAN functions that can be supported or a service model (e.g. E2SM) supported for each of the RAN functions. The near-real-time RIC 321 may change a configuration of the E2 node based on the E2 node configuration update request message. The near-real-time RIC 321 may transmit an E2 node configuration update response message to the E2 node based on the configuration change of the E2 node (S514).

In the RIC subscription step S520, the near-real-time RIC 321 may transmit a subscription request message for RAN data to at least one E2 node (S521). For example, the near-real-time RIC 321 may transmit to the E2 node a subscription request message including an event trigger and task contents to be performed when the event trigger occurs. According to an exemplary embodiment, the near-real-time RIC 321 may periodically transmit, to the E2 node, the subscription request message for the RAN data through an app (e.g. xApp) for abnormal terminal detection. According to an exemplary embodiment, the near-real-time RIC 321 may also periodically transmit, to the E2 node, the subscription request message for the RAN data through an app for dedicated RAN data collection. The E2 node may transmit a subscription response message to the near-real-time RIC 321 based on the subscription request message for the RAN data (S522).

In the RIC indication step S530, the near-real-time RIC 321 may receive RAN data, for example, KPM data, from at least one E2 node (S531). For example, when an event based on the subscription request for the RAN data occurs, the E2 node may transmit, to the near-real-time RIC 321, the subscription-requested RAN data for the event. In this case, the E2 node may transmit the RAN data to the near-real-time RIC 321 through a RIC indication message. An event in the E2 node may occur periodically. The near-real-time RIC 321 may periodically receive the RAN data from the E2 node and may store the received RAN data in a time-series database (DB) (S533).

In the abnormal terminal detection step S540, the near-real-time RIC 321 may access the time-series DB through an xApp and may detect an abnormal terminal based on the RAN data stored in the time-series DB (S541). For example, the near-real-time RIC 321 may include a pre-trained abnormal terminal detection model, and may detect the abnormal terminal from the RAN data by using the abnormal terminal detection model.

The near-real-time RIC 321 may transmit information on the detected abnormal terminal to at least one E2 node (S542). The E2 node may transmit a handover indication (or command) to the corresponding terminal based on the abnormal terminal information, or may allocate more scheduling opportunities to the corresponding terminal. According to an exemplary embodiment, the near-real-time RIC 321 may transmit a handover control message for the detected abnormal terminal to the E2 node. The E2 node may transmit a handover indication (or command) to the corresponding terminal based on the handover control message.

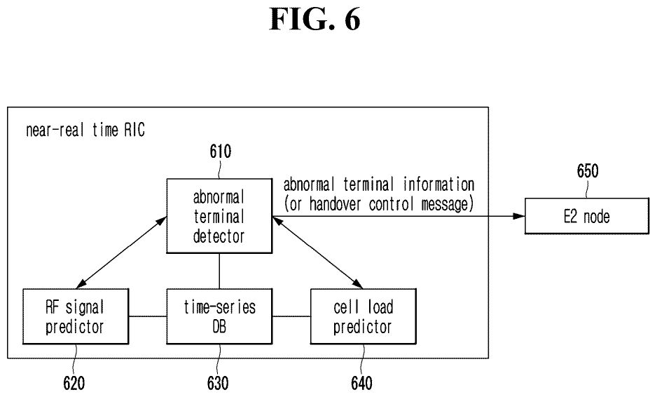

FIG. 6 is a block diagram illustrating an exemplary embodiment of an abnormal terminal detection model of a RAN intelligent controller.

Referring to FIG. 6, the near-real-time RIC may detect an abnormal terminal based on RAN data collected from at least one E2 node by using the abnormal terminal detection model. The abnormal terminal detection model may include an abnormal terminal detector 610, an RF signal predictor 620, and a cell load predictor 640. The abnormal terminal detector 610, the RF signal predictor 620, and the cell load predictor 640 may be connected to a time-series database (DB) 630 storing RAN data (e.g. time-series KPM data) collected from at least one E2 node. Each of the abnormal terminal detector 610, the RF signal predictor 620, and the cell load predictor 640 may be configured as an individual app (xApp), or may be configured as a plurality of function blocks within a single app.

The abnormal terminal detector 610 may detect at least one abnormal terminal based on the RAN data stored in the time-series DB 630. The abnormal terminal detector 610 may transmit an RF signal prediction request message for the abnormal terminal to the RF signal predictor 620. In addition, the abnormal terminal detector 610 may transmit a cell load prediction request message for the abnormal terminal to the cell load predictor 640.

The RF signal predictor 620 may predict an RF signal of the corresponding abnormal terminal based on the RF signal prediction request message received from the abnormal terminal detector 610. For example, the RF signal predictor 620 may predict an RF signal of the abnormal terminal in a serving cell or may predict an RF signal of the abnormal terminal in at least one neighbor cell adjacent to the serving cell based on the RAN data of the abnormal terminal stored in the time-series DB 630. The RF signal predictor 620 may transmit RF signal prediction information for the abnormal terminal to the abnormal terminal detector 610. The RF signal prediction information may include at least one of RSRP, RSRQ, or RS_SINR.

The cell load predictor 640 may predict a cell load of the corresponding abnormal terminal based on the cell load prediction request message received from the abnormal terminal detector 610. For example, the cell load predictor 640 may predict a cell load for the abnormal terminal in the serving cell or may predict a cell load for the abnormal terminal in at least one neighbor cell adjacent to the serving cell based on the RAN data of the abnormal terminal stored in the time-series DB 630. The cell load predictor 640 may transmit cell load prediction information for the abnormal terminal to the abnormal terminal detector 610. The cell load prediction information may include at least one of a downlink PRB usage amount (e.g. DLPU) or an uplink PRB usage amount (e.g. ULPU).

The abnormal terminal detector 610 may transmit abnormal terminal information for at least one detected abnormal terminal to the E2 node. The abnormal terminal information may include at least one of an identifier of the corresponding terminal, RF signal prediction information or cell load information for the serving cell of the terminal or for at least one neighbor cell. The abnormal terminal detector 610 may transmit to the E2 node the abnormal terminal information as shown in Table 2 below.

TABLE 2

| Items to | | | | |
|---|---|---|---|---|
| predict | Serving Cell | Neighbor Cell#1 | . . . | Neighbor Cell#n |
| RSRP | [RSRPₜ₊₁, | [RSRPₜ₊₁, | . . . | [RSRPₜ₊₁, |
| | RSRPₜ₊₂, . . . , | RSRPₜ₊₂, . . . , | | RSRPₜ₊₂, . . . , |
| | RSRPₜ₊ₚ] | RSRPₜ₊ₚ] | | RSRPₜ₊ₚ] |
| RSRQ | [RSRQₜ₊₁, | [RSRQₜ₊₁, | . . . | [RSRQₜ₊₁, |
| | RSRQₜ₊₂, . . . , | RSRQₜ₊₂, . . . , | | RSRQₜ₊₂, . . . , |
| | RSRQₜ₊ₚ] | RSRQₜ₊ₚ] | | RSRQₜ₊ₚ] |
| RS_SINR | [SINRₜ₊₁, | [SINRₜ₊₁, | . . . | [SINRₜ₊₁, |
| | SINRₜ₊₂, . . . , | SINRₜ₊₂, . . . , | | SINRₜ₊₂, . . . , |
| | SINRₜ₊ₚ] | SINRₜ₊ₚ] | | SINRₜ₊ₚ] |
| DL PRB | [DLPUₜ₊₁, | [DLPUₜ₊₁, | . . . | [DLPUₜ₊₁, |
| Usage | DLPUₜ₊₂, . . . , | DLPUₜ₊₂, . . . , | | DLPUₜ₊₂, . . . , |
| (DLPU) | DLPUₜ₊ₚ] | DLPUₜ₊ₚ] | | DLPUₜ₊ₚ] |
| UL PRB | [ULPUₜ₊₁, | [ULPUₜ₊₁, | . . . | [ULPUₜ₊₁, |
| Usage | ULPUₜ₊₂, . . . , | ULPUₜ₊₂, . . . , | | ULPUₜ₊₂, . . . , |
| (ULPU) | ULPUₜ₊ₚ] | ULPUₜ₊ₚ] | | ULPUₜ₊ₚ] |

According to an exemplary embodiment, the abnormal terminal detector 610 may transmit a handover control message for at least one abnormal terminal to the E2 node. The handover control message may include information on a cell in which a handover of the abnormal terminal is to be performed, for example, information on a neighbor cell having the best RF signal or the lowest cell load among at least one neighbor cell of the abnormal terminal.

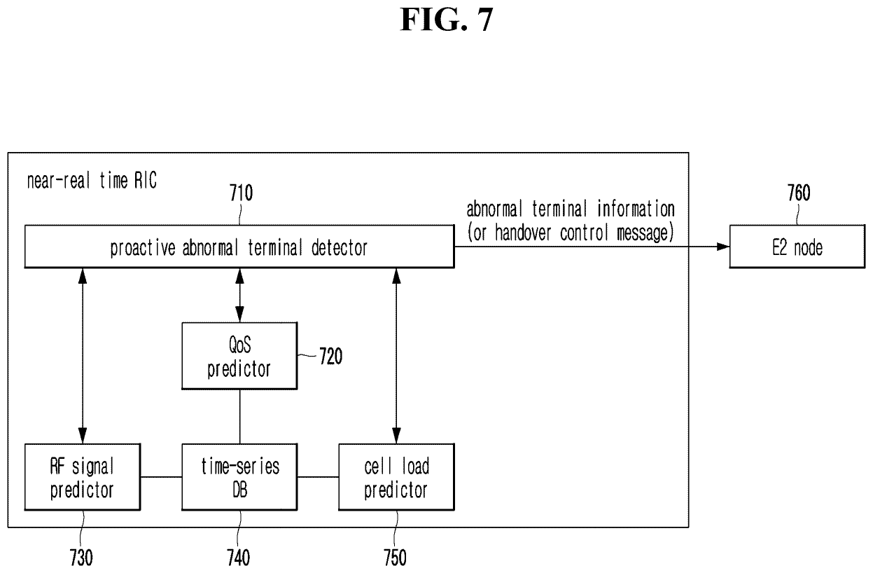

FIG. 7 is a block diagram illustrating another exemplary embodiment of an abnormal terminal detection model of a RAN intelligent controller.

Referring to FIG. 7, the near-real-time RIC may detect an abnormal terminal based on RAN data collected from at least one E2 node by using the abnormal terminal detection model. The abnormal terminal detection model may include a proactive abnormal terminal detector 710, a QoS predictor 720, an RF signal predictor 730, and a cell load predictor 750. The QoS predictor 720, the RF signal predictor 730, and the cell load predictor 750 may be connected to a time-series database (DB) 740 storing RAN data (e.g. time-series KPM data) collected from at least one E2 node. Each of the proactive abnormal terminal detector 710, the QoS predictor 720, the RF signal predictor 730, and the cell load predictor 750 may be configured as an individual app (xApp), or may be configured as a plurality of function blocks within a single app.

The proactive abnormal terminal detector 710 may proactively detect an abnormal terminal based on at least one piece of prediction information among QoS prediction information, RF signal prediction information, or cell load prediction information received from each of the QoS predictor 720, the RF signal predictor 730, and the cell load predictor 750. The proactive abnormal terminal detector 710 may transmit a prediction request message to each of the QoS predictor 720, the RF signal predictor 730, and the cell load predictor 750.

The QoS predictor 720 may predict QoS of each of a plurality of terminals based on the prediction request message received from proactive abnormal terminal detector 710. For example, the QoS predictor 720 may predict a QoS of each terminal in a serving cell or a QoS of each terminal in at least one neighbor cell adjacent to the serving cell, based on RAN data of each terminal stored in the time-series DB 740. The QoS predictor 720 may transmit QoS prediction information of each terminal to the proactive abnormal terminal detector 710.

The RF signal predictor 730 may predict RF signals of a plurality of terminals based on the prediction request message received from the proactive abnormal terminal detector 710. For example, the RF signal predictor 730 may predict, based on RAN data of each terminal stored in the time-series DB 740, RF signals of each terminal in the serving cell or RF signals of each terminal in at least one neighbor cell adjacent to the serving cell. The RF signal predictor 730 may transmit RF signal prediction information for each terminal to the proactive abnormal terminal detector 710. The RF signal prediction information may include at least one of RSRP, RSRQ, or RS_SINR.

The cell load predictor 750 may predict a cell load of each of a plurality of terminals based on the prediction request message received from proactive abnormal terminal detector 710. For example, the cell load predictor 750 may predict a cell load in the serving cell or a cell load in at least one neighbor cell adjacent to the serving cell, based on RAN data of each terminal stored in the time-series DB 740. The cell load predictor 750 may transmit cell load prediction information for each terminal to the proactive abnormal terminal detector 710. The cell load prediction information may include at least one of downlink PRB usage (e.g. DLPU) or uplink PRB usage (e.g. ULPU).

The proactive abnormal terminal detector 710 may detect at least one abnormal terminal among a plurality of terminals based on the prediction information received from at least one of the QoS predictor 720, the RF signal predictor 730, or the cell load predictor 750. Here, each of the QoS predictor 720, the RF signal predictor 730, or the cell load predictor 750 may perform the prediction operation based on RAN data stored in the time-series DB 740, and the RAN data may be data that changes over time. Therefore, the proactive abnormal terminal detector 710 may proactively detect at least one abnormal terminal that may cause an abnormal condition after a specific time among the plurality of terminals, based on the prediction information received from at least one of the QoS predictor 720, the RF signal predictor 730, or the cell load predictor 750.

The proactive abnormal terminal detector 710 may transmit abnormal terminal information regarding the at least one detected abnormal terminal to an E2 node. The abnormal terminal information may include at least one of an identifier of the corresponding terminal, QoS information regarding a serving cell or at least one neighbor cell of the terminal, the RF signal prediction information, or the cell load information. The proactive abnormal terminal detector 710 may transmit the abnormal terminal information as shown below in Table 3 to the E2 node.

TABLE 3

| Items to | | | | |
|---|---|---|---|---|
| predict | Serving Cell | Neighbor Cell#1 | . . . | Neighbor Cell#n |
| DL Tput | [DLTPₜ₊₁, | — | | — |
| (DLTP) | DLTPₜ₊₂, . . . , | | | |
| | DLTPₜ₊ₚ] | | | |
| UL Tput | [ULTPₜ₊₁, | — | | — |
| (ULTP) | ULTPₜ₊₂, . . . , | | | |
| | ULTPₜ₊ₚ] | | | |
| RSRP | [RSRPₜ₊₁, | [RSRPₜ₊₁, | . . . | [RSRPₜ₊₁, |
| | RSRPₜ₊₂, . . . , | RSRPₜ₊₂, . . . , | | RSRPₜ₊₂, . . . , |
| | RSRPₜ₊ₚ] | RSRPₜ₊ₚ] | | RSRPₜ₊ₚ] |
| RSRQ | [RSRQₜ₊₁, | [RSRQₜ₊₁, | . . . | [RSRQₜ₊₁, |
| | RSRQₜ₊₂, . . . , | RSRQₜ₊₂, . . . , | | RSRQₜ₊₂, . . . , |
| | RSRQₜ₊ₚ] | RSRQₜ₊ₚ] | | RSRQₜ₊ₚ] |
| RS_SINR | [SINRₜ₊₁, | [SINRₜ₊₁, | . . . | [SINRₜ₊₁, |
| | SINRₜ₊₂, . . . , | SINRₜ₊₂, . . . , | | SINRₜ₊₂, . . . , |
| | SINRₜ₊ₚ] | SINRₜ₊ₚ] | | SINRₜ₊ₚ] |
| DL PRB | [DLPUₜ₊₁, | [DLPUₜ₊₁, | . . . | [DLPUₜ₊₁, |
| Usage | DLPUₜ₊₂, . . . , | DLPUₜ₊₂, . . . , | | DLPUₜ₊₂, . . . , |
| (DLPU) | DLPUₜ₊ₚ] | DLPUₜ₊ₚ] | | DLPUₜ₊ₚ] |
| UL PRB | [ULPUₜ₊₁, | [ULPUₜ₊₁, | . . . | [ULPUₜ₊₁, |
| Usage | ULPUₜ₊₂, . . . , | ULPUₜ₊₂, . . . , | | ULPUₜ₊₂, . . . , |
| (ULPU) | ULPUₜ₊ₚ] | ULPUₜ₊ₚ] | | ULPUₜ₊ₚ] |

According to an exemplary embodiment, the proactive abnormal terminal detector 710 may transmit a handover control message regarding the at least one abnormal terminal to the E2 node. The handover control message may include information regarding a cell to which handover of the abnormal terminal is to be performed, for example, information regarding a neighbor cell having the best RF signal or the lowest cell load among at least one neighbor cell of the abnormal terminal.

The RF signal predictors 620 and 730, the cell load predictors 640 and 750, or the QoS predictor 720 shown in FIG. 6 and FIG. 7 may be time-series data predictors. The RF signal predictors 620 and 730, the cell load predictors 640 and 750, or the QoS predictor 720 may predict time-series data by using at least one ML algorithm among an autoregressive (AR) model, a vector autoregressive (VAR) model, an autoregressive integrated moving average (ARIMA) model, or a seasonal ARIMA model. In addition, the RF signal predictors 620 and 730, the cell load predictors 640 and 750, or the QoS predictor 720 may predict time-series data by using at least one deep neural network-based algorithm among a recurrent neural network (RNN), a long short-term memory (LSTM), or a transformer. The RF signal predictors 620 and 730, the cell load predictors 640 and 750, or the QoS predictor 720 may predict time-series data for each of the plurality of terminals in a specific time duration.

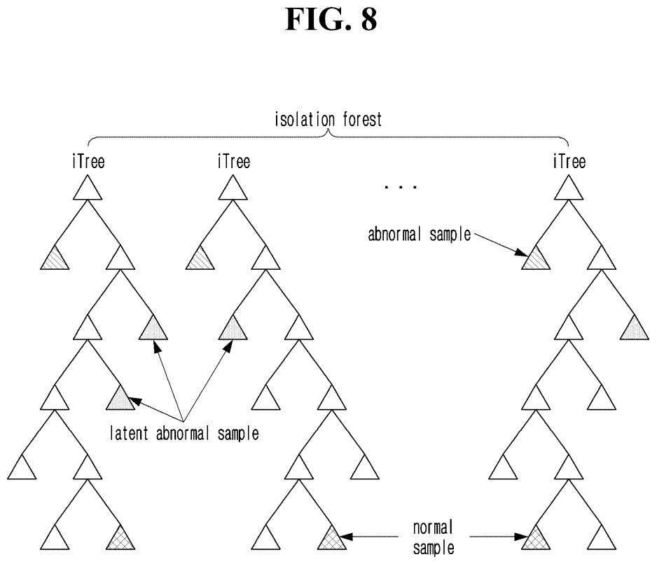

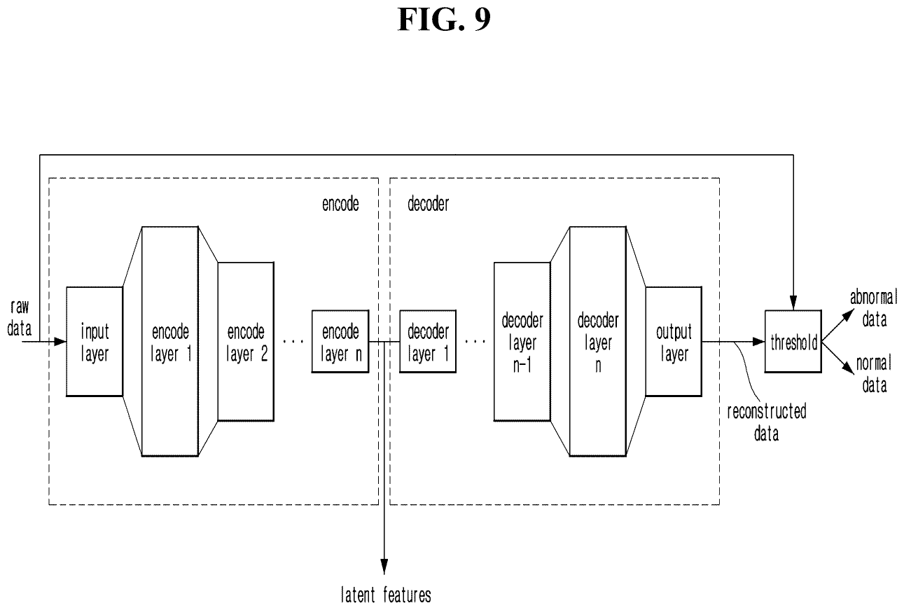

FIG. 8 is a conceptual diagram illustrating an exemplary embodiment of an isolation forest model for abnormal terminal detection, and FIG. 9 is a conceptual diagram illustrating an exemplary embodiment of an autoencoder model for abnormal terminal detection.

Referring to FIG. 8, the abnormal terminal detection model may be an isolation forest (IF) model. The IF model may distinguish input data as either normal data or abnormal data. The IF model may be trained to distinguish normal data and abnormal data through unsupervised machine learning (or training) without labels for the input data.

Referring to FIG. 9, the abnormal terminal detection model may be an autoencoder (AE) model. The AE model may generate latent feature representations through dimensionality reduction of an encoder for input data and may generate reconstructed data having various data representations through reconstructed data representations of a decoder. The AE model may be trained, through unsupervised deep learning, to compress input data to a latent space representation layer size and to effectively reconstruct the input data with a minimal reconstruction error. Here, since a reconstruction error may increase when the input data is abnormal data, abnormality of the input data may be distinguished from the reconstructed data.

The IF model or the AE model of FIG. 8 and FIG. 9 may require at least one of parameter optimization or identification of importance for data feature items in order to derive an optimal result. The IF model or the AE model may perform optimization through model training or model evaluation for parameter optimization or identification of importance of feature items. In this case, the IF model or the AE model may require labels capable of distinguishing normal or abnormal for the input data in performing model training or model evaluation. Hereinafter, a method of optimization through training of the IF model or the AE model will be described.

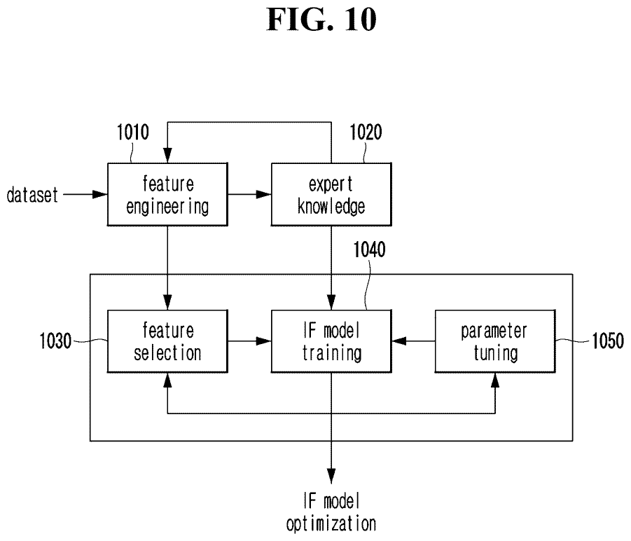

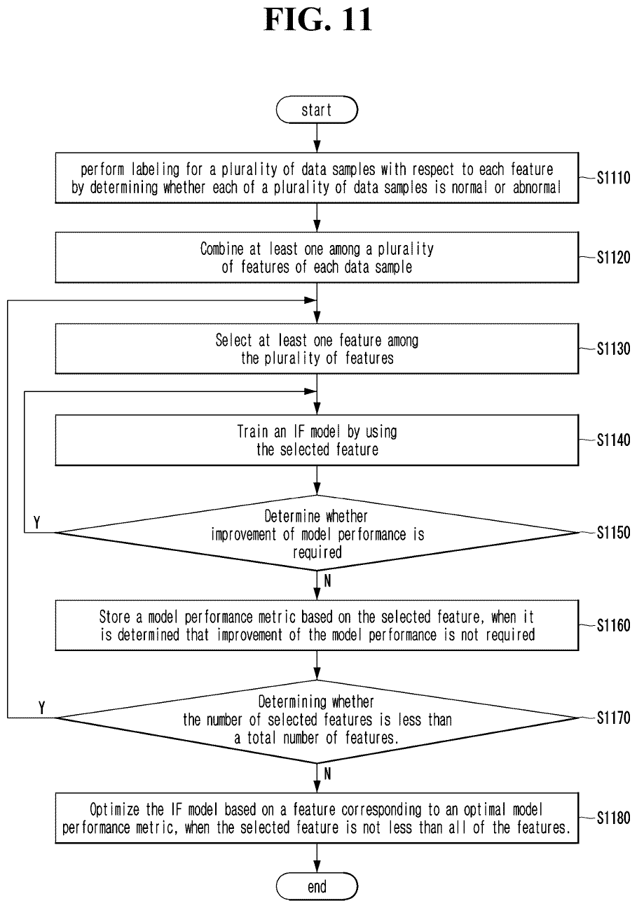

FIG. 10 is a conceptual diagram illustrating an exemplary embodiment for optimization of an isolation forest model, and FIG. 11 is a flowchart illustrating an exemplary embodiment of a method for optimization of an isolation forest model.

Referring to FIG. 10 and FIG. 11, an isolation forest (IF) model may optimize parameter identification or identification of importance of feature items through model training utilizing expert knowledge.

The IF model may construct a dataset for training. The dataset may include a plurality of data samples, and each data sample may include a feature regarding at least one item among the plurality of items disclosed in Table 1.

A feature engineering block 1010 may receive the dataset and may transmit the dataset to an expert knowledge block 1020. The expert knowledge block 1020 may distinguish each of a plurality of data samples of the dataset as normal or abnormal by using preconfigured expert knowledge. For example, the expert knowledge block 1020 may set a threshold for each feature of the data. The expert knowledge block 1020 may compare each feature of each data sample with the threshold for each preconfigured feature, and may determine normal or abnormal of the corresponding data sample based on a comparison result. The expert knowledge block 1020 may perform labeling for each feature of the data sample based on the determination result of normal or abnormal of the data sample (S1110). The expert knowledge block 1020 may transmit the feature-wise labels of the data sample to the feature engineering block 1010 and/or IF model training block 1040.

The feature engineering block 1010 may combine at least one feature among a plurality of features of each data sample based on the feature-wise labels received from the expert knowledge block 1020 (S1120). The feature engineering block 1010 may combine the plurality of features of each of the plurality of data samples by synthesizing, removing, or substituting the plurality of features based on the feature-wise labels.

According to an exemplary embodiment, each of the plurality of data samples may include RF signal quality features of each of a plurality of neighbor cells, for example, RSRP, RSRQ, or RS_SINR. The feature engineering block 1010 may synthesize the RF signal quality features of each data sample based on the RF signal quality feature labels. The synthesized RF signal quality features may be expressed as in Equation 1 below.

$$Max\_RSRP \_dBm \_nbrCell = {max}_{∀ i ∈ \{ 1 , 2 , … , n \}} RSRP\_dBm \_nbrCell \#i \qquad [ Equation 1 ]$$

$$Max\_RSRQ \_dB \_nbrCell = {max}_{∀ i ∈ \{ 1 , 2 , … , n \}} RSRQ\_dB \_nbrCell \#i$$

$$Max\_RS \_SINR \_dB \_nbrCell = {max}_{∀ i ∈ \{ 1 , 2 , … , n \}} RS\_SINR \_dB \_nbrCell \#i$$

Here, nbrCell #i may denote a total number of neighbor cells.

According to an exemplary embodiment, the feature engineering block 1010 may represent the RF signal quality features disclosed in Equation 1 as one representative RF signal quality feature. For example, the feature engineering block 1010 may determine an RSRP feature as a representative feature among the synthesized RF signal quality features and may remove an RSRQ feature and an RS_SINR feature except the RSRP feature.

According to an exemplary embodiment, the feature engineering block 1010 may substitute at least one feature having a constant value among the plurality of features of each data sample with another feature. For example, the feature engineering block 1010 may substitute Target_DL_PDCP_tput_Mbps and/or Target_UL_PDCP_tput_Mbps with another feature as shown in Equation 2 below.

$$Target\_DL \_Achievable \_tput \_level = DL\_PDCP \_tput \_Mbps / Target\_DL \_PDCP \_tput \_Mbps \qquad [ Equation 2 ]$$

$$Target\_UL \_Achievable \_tput \_level = UL\_PDCP \_tput \_Mbps / Target\_UL \_PDCP \_tput \_Mbps$$

The feature engineering block 1010 may transmit the dataset to a feature selection block 1030. The dataset may include the plurality of data samples, and each data sample may include at least one feature combined by the feature engineering block 1010. The feature selection block 1030 may select at least one feature among the plurality of features of each data sample (S1130). According to an exemplary embodiment, the feature selection block 1030 may select at least one feature important for model training or evaluation among the plurality of features by using the expert knowledge configured in the expert knowledge block 1020.

The feature selection block 1030 may transmit the selected feature to an IF model training block 1040. The IF model training block 1040 may train the IF model by using the selected feature and/or the feature-wise labels (S1140).

The IF model training block 1040 may adjust at least one parameter value of the IF model through a parameter tuning block 1050 based on a training result of the IF model. In addition, the IF model training block 1040 may calculate a model performance metric based on the training result of the IF model, and may determine whether improvement of model performance is required based on the model performance metric (S1150).

The IF model training block 1040 may repeat training of the IF model by using the selected feature when improvement of model performance is determined to be required. Along with this, the IF model training block 1040 may re-adjust at least one parameter value of the IF model through the parameter tuning block 1050 based on a result of repeated training of the IF model. The IF model training block 1040 may store the selected feature and/or the model performance metric corresponding thereto when improvement of model performance is determined to be unnecessary (S1160).

The IF model training block 1040 may compare a number of the selected features with a number of total features (S1170). The IF model training block 1040 may re-select another feature excluding the selected feature among the plurality of features through feature selection block 1030 when the number of the selected features is smaller than the number of the total features.

The IF model training block 1040 may perform training of the IF model and/or parameter tuning based on the re-selected feature. The IF model training block 1040 may determine whether improvement of model performance is required based on a result of the training. The IF model training block 1040 may repeat training of the IF model based on the determination result, and may store the re-selected feature and a model performance metric corresponding to the re-selected feature.

The IF model training block 1040 may detect a model performance metric that represents optimal performance among at least one stored model performance metric when the number of the selected features is greater than or equal to the number of the total features, and may optimize the IF model by using the selected feature corresponding to the detected model performance metric (S1180). The selected feature for optimization of the IF model may be represented as shown in Table 4 below.

TABLE 4

| Feature #1 | Feature #2 | Feature #3 | Feature #4 |
|---|---|---|---|
| (F #1) | (F #2) | (F #3) | (F #4) |
| DL_PDCP_{—} | DL_PRB_{—} | RS_SINR_dB_{—} | Max_RSRQ_{—} |
| tput_Mbps | usage_servCell | servCell | dB_nbrCell |

Meanwhile, the IF model training block 1040 may perform training of the IF model based on a weight of the selected feature for training of the IF model. The weight may be configured for each feature in the expert knowledge block 1020, and the expert knowledge block 1020 may transmit the configured feature-wise weights to the IF model training block 1040. The IF model training block 1040 may repeat the training for the feature by the weight based on the feature-wise weights. For example, among the features disclosed in Table 4, a first feature (F #1) may have a weight 3, a second feature (F #2) may have a weight 1, a third feature (F #3) may have a weight 2, and a fourth feature (F #4) may have a weight 1. The IF model training block 1040 may repeat model training for the first feature (F #1) three times, may repeat model training for the third feature (F #3) two times, and may perform model training for the second feature (F #2) and the fourth feature (F #4) one time, based on the feature-wise weights.

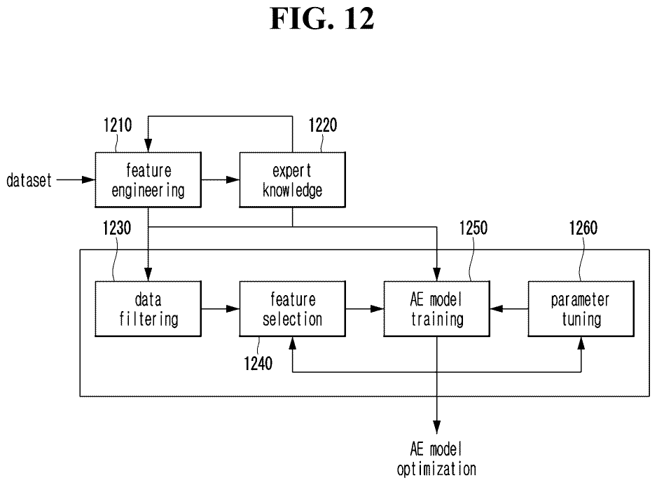

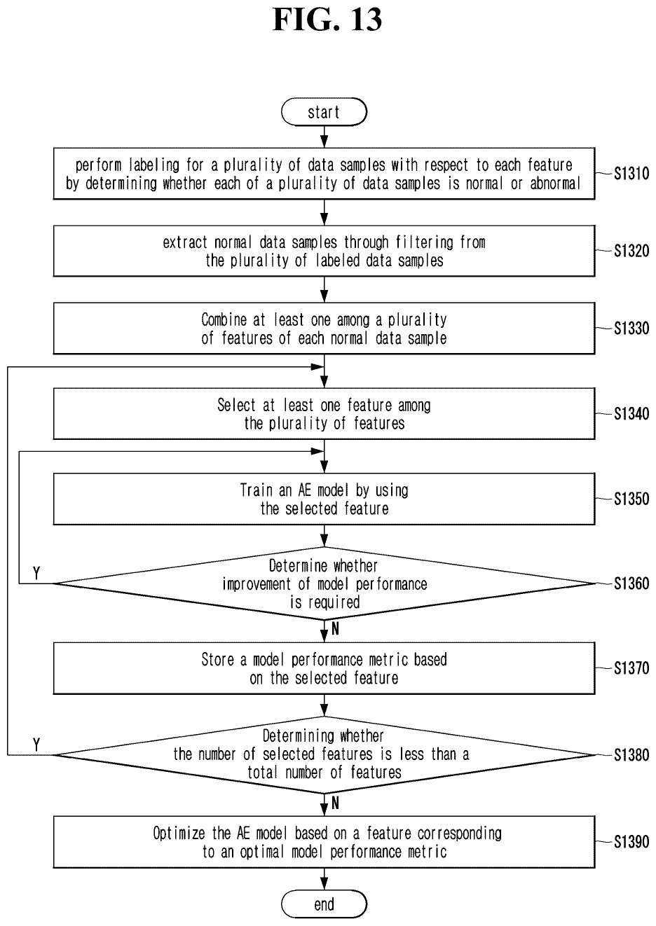

FIG. 12 is a conceptual diagram illustrating an exemplary embodiment for optimization of an autoencoder model, and FIG. 13 is a flowchart illustrating an exemplary embodiment of a method for optimization of an autoencoder model.

Referring to FIG. 12 and FIG. 13, an autoencoder (AE) model may optimize parameter identification or identification of importance of feature items through model training using expert knowledge.

The AE model may construct a dataset for training. The dataset may include a plurality of data samples, and each data sample may include a feature regarding at least one item among the plurality of items disclosed in Table 1.

A feature engineering block 1210 may receive the dataset and may transmit the dataset to an expert knowledge block 1220. The expert knowledge block 1220 may distinguish each of the plurality of data samples of the dataset as normal or abnormal by using preconfigured expert knowledge. For example, the expert knowledge block 1220 may set a threshold for each feature of the data. The expert knowledge block 1220 may compare each feature of each data sample with the threshold for each preconfigured feature, and may determine normal or abnormal of the corresponding data sample based on a comparison result. The expert knowledge block 1220 may perform labeling for each feature of the data sample based on the determination result of normal or abnormal of the data sample (S1310). The expert knowledge block 1220 may transmit the feature-wise labels of the data sample to the feature engineering block 1210, a data filtering block 1230, and/or an AE model training block 1250.

The feature engineering block 1210 may combine at least one feature among a plurality of features of each data sample based on feature-wise labels received from the expert knowledge block 1220 (S1320). The feature engineering block 1210 may combine the plurality of features of each of the plurality of data samples by synthesizing, removing, or substituting the plurality of features based on the feature-wise labels. The feature combination operation of the feature engineering block 1210 may be identical to that described with reference to FIG. 11.

The feature engineering block 1210 may transmit the dataset to the data filtering block 1230. The dataset may include the plurality of data samples, and each data sample may include at least one feature combined by the feature engineering block 1210. The data filtering block 1230 may extract at least one normal data sample among the plurality of data samples of the dataset by performing filtering at least one data sample determined by the expert knowledge block 1220 as normal (S1330). As described above, when the AE model performs model training by using abnormal data samples, performance of the model training may degrade. Therefore, the present disclosure may improve performance of training of the AE model by extracting only normal data samples among the plurality of data samples through the data filtering block 1230.

The data filtering block 1230 may transmit the at least one normal data sample to the feature selection block 1240. As described above, the normal data sample may include a plurality of features, and at least one among the plurality of features may be a feature combined by the feature engineering block 1210.

The feature selection block 1240 may select at least one feature among the plurality of features of the normal data sample (S1340). According to an exemplary embodiment, the feature selection block 1240 may select at least one feature important for model training or evaluation among the plurality of features by using expert knowledge configured in the expert knowledge block 1220.

The feature selection block 1240 may transmit the selected feature to the AE model training block 1250. The AE model training block 1250 may train the AE model by using the selected feature and/or the feature-wise labels (S1350).

The AE model training block 1250 may adjust at least one parameter value of the AE model through a parameter tuning block 1260 based on a training result of the AE model. According to an exemplary embodiment, the AE model training block 1250 may repeat training of the AE model for the corresponding feature by a weight based on a preconfigured feature-wise weight. In addition, the AE model training block 1250 may calculate a model performance metric based on the training result of the AE model, and may determine whether improvement of model performance is required based on the calculated model performance metric (S1360).

The AE model training block 1250 may repeat training of the AE model by using the selected feature when improvement of model performance is determined to be required. Along with this, the AE model training block 1250 may re-adjust at least one parameter value of the AE model through the parameter tuning block 1260 based on a result of repeated training of the AE model. The AE model training block 1250 may store the selected feature and/or a model performance metric corresponding to the selected feature when improvement of model performance is determined to be unnecessary (S1370).

The AE model training block 1250 may compare a number of selected features with a number of total features (S1380). The AE model training block 1250 may re-select another feature excluding the selected feature among the plurality of features through the feature selection block 1240 when the number of the selected features is smaller than the number of the total features.

The AE model training block 1250 may perform training of the AE model and/or parameter tuning based on the re-selected feature. The AE model training block 1250 may determine whether improvement of model performance is required based on a result of the training. The AE model training block 1250 may repeat training of the AE model based on the determination result, and may store the re-selected feature and a model performance metric corresponding to the re-selected feature.

The AE model training block 1250 may detect a model performance metric representing optimal performance among at least one stored model performance metric when the number of the selected features is greater than or equal to the number of the total features, and may optimize the AE model by using the selected feature corresponding to the detected model performance metric (S1390).

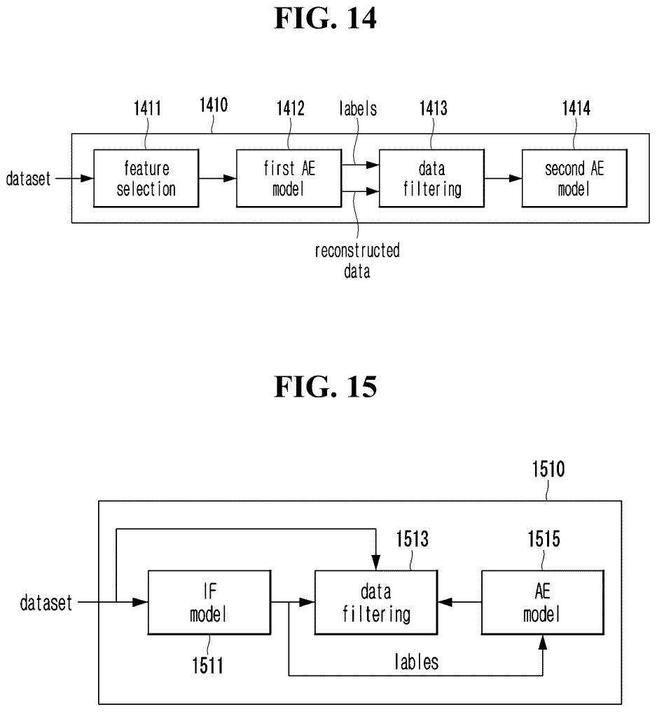

FIG. 14 is a conceptual diagram illustrating an exemplary embodiment for optimization of a plurality of autoencoder models.

Referring to FIG. 14, an abnormal terminal detection model 1410 may include two or more AE models, for example, a first AE model 1412 and a second AE model 1414. Here, the first AE model 1412 and the second AE model 1414 may be connected in series, and the first AE model 1412 may be in a trained and optimized state.

The abnormal terminal detection model 1410 may construct a dataset for training and optimization of the second AE model 1414. The dataset may include a plurality of data samples, and each data sample may include a plurality of features.

A feature selection block 1411 may select at least one feature among the plurality of features of each data sample. According to an exemplary embodiment, the feature selection block 1411 may select at least one feature important for model training or evaluation among the plurality of features by using expert knowledge.

The feature selection block 1411 may transmit the selected feature to the first AE model 1412. The first AE model 1412 may output reconstructed data and labels for the feature of the reconstructed data based on the received feature. The first AE model 1412 may transmit the reconstructed data samples and the labels to a data filtering block 1413.

The data filtering block 1413 may extract normal data samples among the reconstructed data samples by filtering based on the received labels. The data filtering block 1413 may transmit the normal data samples to the second AE model 1414.

The second AE model 1414 may perform at least one model training by using at least one feature among a plurality of features of the received normal data samples. The second AE model 1414 may tune at least one parameter value based on a training result. The second AE model 1414 may optimize the AE model based on at least one selected feature representing an optimal model performance metric based on the training result.

In FIG. 14, the feature selection block 1411 and the data filtering block 1413 are illustrated as separate components from the first AE model 1412 and the second AE model 1414. However, the present disclosure is not limited thereto. For example, the feature selection block 1411 may be included in the first AE model 1412, and the data filtering block 1413 may be included in the second AE model 1414.

FIG. 15 is a conceptual diagram illustrating an exemplary embodiment for optimization of a hybrid model.

Referring to FIG. 15, a hybrid model 1510 may include two different models, for example, an IF model 1511 and an AE model 1515. Here, the IF model 1511 may be in a trained and optimized state.

The hybrid model 1510 may construct a dataset for training and optimization of the AE model 1515. The dataset may include a plurality of data samples, and each data sample may include a plurality of features.

The IF model 1511 may distinguish the plurality of data samples of the dataset as normal data samples and abnormal data samples and may label each of the normal data samples and abnormal data samples. The IF model 1511 may transmit labels of each of the normal data samples and the abnormal data samples to a data filtering block 1513.

The data filtering block 1513 may extract normal data samples among the plurality of data samples of the dataset by filtering based on the received labels. The data filtering block 1513 may transmit the normal data samples to the AE model 1515. According to an exemplary embodiment, the data filtering block 1513 may be included in the AE model 1515.

The AE model 1515 may perform at least one model training by using at least one feature among a plurality of features of the received normal data samples. The AE model 1515 may tune at least one parameter value based on a training result. The AE model 1515 may optimize the AE model based on at least one selected feature representing an optimal model performance metric based on the training result.

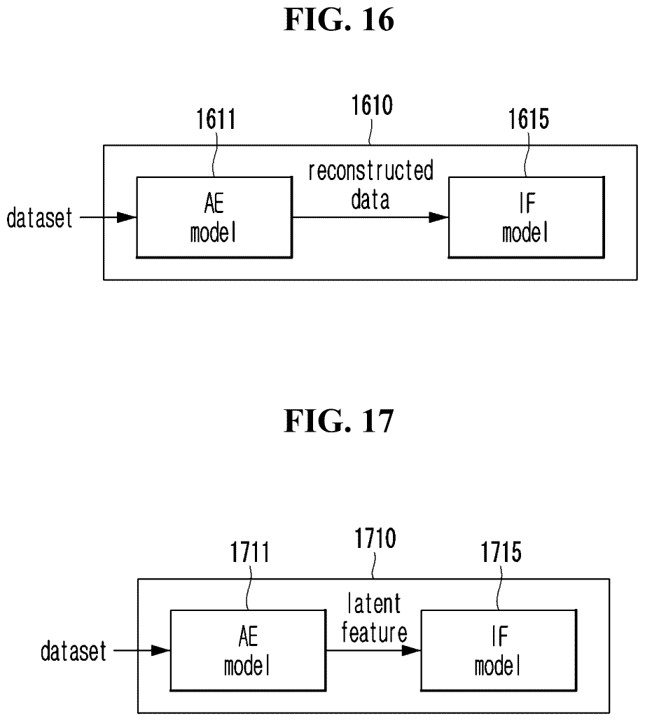

FIG. 16 is a conceptual diagram illustrating another exemplary embodiment for optimization of a hybrid model.

Referring to FIG. 16, a hybrid model 1610 may include two different models, for example, an AE model 1611 and an IF model 1615. The AE model 1611 and the IF model 1615 may be connected in series.

The hybrid model 1610 may construct a dataset for training and optimization of the models. The dataset may include a plurality of data samples, and each data sample may include a plurality of features.

The AE model 1611 may extract at least one normal data sample among the plurality of data samples of the dataset and may perform optimization through at least one model training and parameter tuning by using a plurality of features of the extracted normal data sample. The optimized AE model 1611 may generate at least one reconstructed data sample for the plurality of data samples of the dataset and may transmit the at least one reconstructed data sample to the IF model 1615. The IF model 1615 may perform optimization through at least one model training and parameter tuning by using the plurality of features of the received reconstructed data sample.

FIG. 17 is a conceptual diagram illustrating yet another exemplary embodiment for optimization of a hybrid model.

Referring to FIG. 17, a hybrid model 1710 may include two different models, for example, an AE model 1711 and an IF model 1715. The AE model 1711 and the IF model 1715 may be connected in series.

The hybrid model 1710 may construct a dataset for training and optimization. The dataset may include a plurality of data samples, and each data sample may include a plurality of features.

The AE model 1711 may extract at least one normal data sample among the plurality of data samples of the dataset and may perform optimization through at least one model training and parameter tuning by using a plurality of features of the extracted normal data sample. The optimized AE model 1711 may generate at least one latent feature for the plurality of data samples of the dataset and may transmit the at least one latent feature to the IF model 1715. The IF model 1715 may perform optimization through at least one model training and parameter tuning based on the received latent feature.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A method of a radio access network (RAN) intelligent controller (RIC), the method comprising:
receiving, from a base station, RAN data for each of a plurality of terminals;
predicting, based on the RAN data and by using an abnormal terminal detection model, at least one abnormal terminal among the plurality of terminals to generate abnormal terminal information; and
transmitting, to the base station, at least one of the abnormal terminal information or a handover control message for the at least one abnormal terminal.

2. The method of claim 1, wherein the generating of the abnormal terminal information comprises:
generating signal prediction information for the at least one abnormal terminal based on the RAN data;
generating cell load prediction information for the at least one abnormal terminal based on the RAN data; and
generating the abnormal terminal information including at least one of the signal prediction information or the cell load prediction information.

3. The method of claim 2, wherein the generating of the abnormal terminal information further comprises:
generating quality of service (QoS) prediction information for the at least one abnormal terminal based on the RAN data; and
generating the abnormal terminal information including at least one of the signal prediction information, the cell load prediction information, or the QoS prediction information.

4. The method of claim 1, further comprising optimizing the abnormal terminal detection model, wherein the optimizing comprises:
combining, by using expert knowledge, at least one of a plurality of features of each of a plurality of data samples;
selecting at least one feature among the plurality of features to train the abnormal terminal detection model;
determining, based on a training result, whether performance improvement of the abnormal terminal detection model is required;
based on determining that the performance improvement is not required, storing model performance metrics for the selected at least one feature; and
optimizing the abnormal terminal detection model based on a feature corresponding to an optimal performance metric among the stored model performance metrics.

5. The method of claim 4, wherein the optimizing further comprises: repeatedly training the abnormal terminal detection model according to preset weights, based on determining that the performance improvement of the abnormal terminal detection model is required.

6. The method of claim 4, wherein the optimizing further comprises: reselecting at least one other feature among the plurality of features, based on determining that a number of the selected at least one feature is smaller than a total number of the plurality of features.

7. The method of claim 4, wherein the optimizing further comprises:
distinguishing, by using expert knowledge, each of the plurality of data samples as a normal data sample or an abnormal data sample; and
extracting the normal data samples by filtering the plurality of data samples.

8. The method of claim 4, wherein the abnormal terminal detection model comprises a first model and a second model connected in series, and the optimizing further comprises:
outputting, by using the first model, a prediction result for the selected at least one feature; and
optimizing the second model based on the prediction result of the first model.

9. The method of claim 1, further comprising:
transmitting a RAN data subscription request to the base station; and
receiving, from the base station, the RAN data for each of the plurality of terminals based on the subscription request.

10. A radio access network (RAN) intelligent controller (RIC) comprising at least one processor, wherein the at least one processor causes the RAN intelligent controller to:
receive, from a base station, RAN data for each of a plurality of terminals;
predict, based on the RAN data and by using an abnormal terminal detection model, at least one abnormal terminal among the plurality of terminals to generate abnormal terminal information; and
transmit, to the base station, at least one of the abnormal terminal information or a handover control message for the at least one abnormal terminal.

11. The RAN intelligent controller of claim 10, wherein in the generating of the abnormal terminal information, the at least one processor causes the RAN intelligent controller to:
generate signal prediction information for the at least one abnormal terminal based on the RAN data;
generate cell load prediction information for the at least one abnormal terminal based on the RAN data; and
generate the abnormal terminal information including at least one of the signal prediction information or the cell load prediction information.

12. The RAN intelligent controller of claim 11, wherein in the generating of the abnormal terminal information, the at least one processor causes the RAN intelligent controller to:
generate quality of service (QoS) prediction information for the at least one abnormal terminal based on the RAN data; and
generate the abnormal terminal information including at least one of the signal prediction information, the cell load prediction information, or the QoS prediction information.

13. The RAN intelligent controller of claim 10, wherein the at least one processor further causes the RAN intelligent controller to:
combine, by using expert knowledge, at least one of a plurality of features of each of a plurality of data samples;
select at least one feature among the plurality of features to train the abnormal terminal detection model;
determine, based on a training result, whether performance improvement of the abnormal terminal detection model is required;
based on determining that the performance improvement is not required, store model performance metrics for the selected at least one feature; and
optimize the abnormal terminal detection model based on a feature corresponding to an optimal performance metric among the stored model performance metrics.

14. The RAN intelligent controller of claim 13, wherein the at least one processor further causes the RAN intelligent controller to: repeatedly train the abnormal terminal detection model according to preset weights, based on determining that the performance improvement of the abnormal terminal detection model is required.

15. The RAN intelligent controller of claim 13, wherein the at least one processor further causes the RAN intelligent controller to: reselect at least one other feature among the plurality of features, based on determining that a number of the selected at least one feature is smaller than a total number of the plurality of features.

16. The RAN intelligent controller of claim 13, wherein the at least one processor further causes the RAN intelligent controller to:
distinguish, by using expert knowledge, each of the plurality of data samples as a normal data sample or an abnormal data sample; and
extract the normal data samples by filtering the plurality of data samples.

17. The RAN intelligent controller of claim 13, wherein the abnormal terminal detection model comprises a first model and a second model connected in series, and the at least one processor further causes the RAN intelligent controller to:
output, by using the first model, a prediction result for the selected at least one feature; and
optimize the second model based on the prediction result of the first model.

18. The RAN intelligent controller of claim 10, wherein the at least one processor further causes the RAN intelligent controller to:
transmit a RAN data subscription request to the base station; and
receive, from the base station, the RAN data for each of the plurality of terminals based on the subscription request.
